(19) United States
(12) Patent Application Publication
(10) Pub. No.: US 2017/0122488 A1
(43) Pub. Date: May 4, 2017

(54) Encapsulation System and Kit for a Length of Pipe Disposed Underground

(71) Applicant: Platinum Insulating Services Ltd., Grande Prairie (CA)

(72) Inventors: Paul Dagesse, Beaverlodge (CA); Pat Minamide, Grande Prairie (CA); Mike Dagleish, Grande Prairie (CA)

(21) Appl. No.: 15/337,647

(22) Filed: Oct. 28, 2016

Related U.S. Application Data
(63) Continuation-in-part of application No. 14/928,160, filed on Oct. 30, 2015.

(51) Int. Cl. F16L 57/06; B29C 65/00; F16L 3/123

(52) U.S. Cl. CPC F16L 57/06; F16L 3/1236; B29C 66/727; B29C 66/547; B29L 2023/22

(57) ABSTRACT

A kit for encapsulating a length of pipe features first and second foam sections cooperatively shaped to form a cavity with open ends in a working configuration of the foam sections for receiving the length of pipe therein. A foam lower in density than the material of the foam sections fills an unoccupied space in the cavity, providing cushioning for the pipe in the cavity such that movement is permitted and stress on the pipe is reduced. The foam sections feature cooperating ridges and grooves at mating faces of the respective section which are on either side of a channel that cooperates with the channel of the other section to form the cavity. The ridges and grooves when mated hold the foam sections in fixed relation to one another. Also, the foam sections feature passageways such that the cavity is accessible from outside the foam sections in the working configuration thereby facilitating connection apparatus such as for cathodic protection equipment.

This application is a continuation-in-part of parent application U.S. Ser. No. 14/928,160 filed Oct. 30, 2015 which is incorporated herein by reference.

### FIELD OF THE INVENTION

The present invention relates generally to underground piping such as pipelines carrying one of oil and gas, and more particularly to arrangements for protecting underground piping such as from abrasive contents in the ground and traffic impact.

### BACKGROUND

Underground piping is employed to carry fluids across significant distances. In the oil and gas industry, pipelines are significant investments intended to be operable for long after their installation. Furthermore, the oil or gas carried by these pipelines presents substantial environmental risks and lost revenues in the event that the pipeline ruptures. For example, rupture may occur due to stress exerted on the pipeline by abrasive contents in the ground, such as rocks, as the piping moves in the ground due to thermal expansion and contraction. The abrasive contents form pressure points externally on the piping which may eventually cause rupture.

Thus, it is desirable to provide a unique solution for protecting pipelines installed in the ground.

### SUMMARY OF THE INVENTION

According to an aspect of the invention there is provided a kit for encapsulating a length of pipe which is disposable underground in a subterranean environment and has a pre-specified diameter, the kit comprising: elongate first and second foam sections extending in a longitudinal axis along the length of pipe that are shaped to cooperatively form a longitudinally elongate cavity with open longitudinal ends in a working configuration of the foam sections for receiving the length of pipe in said cavity so as to enclose the length of pipe around its full circumference thereby shielding the length of pipe, wherein one of the foam sections defines a bottom covering usable for positioning beneath the length of pipe and one of the foam sections defines a top covering usable for positioning over the length of pipe.

The first and second foam sections provide direct protection from an external environment surrounding the length of pipe such as debris and abrasive articles or contents such as rocks disposed in the ground.

Typically there is provided a securing arrangement for holding the first and second foam sections in the working configuration;

Preferably there is provided a volume of low density foam which is less dense than a material of the first and second foam sections for filling unoccupied space in the cavity, whereby the volume of low density foam provides cushioning for the length of pipe such that movement of the length of pipe within the cavity is permitted and stress on the length of pipe is reduced.

In the embodiment described in more detail hereinafter, a reinforcing membrane lines the cavity so as to provide direct support to the length of pipe residing thereon thereby dissipating stress due to weight of the length of pipe that may be exerted on the foam section that defines the bottom covering. Additional reinforcing membranes are carried at or adjacent outside faces of the foam sections so as to resist deformation, such as puncturing, of the foam sections by contents of the subterranean environment. Additionally, the low density foam provides cushioning for the length of pipe so as to reduce pressure thereon originating from an external source outside the first and second foam sections and transmitted therethrough. Furthermore, the low density foam allows the length of pipe to move within the cavity, such as movement due to thermal expansion and contraction, while resisting formation of pressure on the length of pipe due to the kit or encapsulation system that may be caused by this pipe movement within the cavity. Additionally, the foam material, such as of the foam sections, may be suited for thermally insulating the length of pipe so as to resist frost build up thereon and reduce thermal expansion and contraction of the pipe. Moreover, for example, the encapsulation kit may be suited for protecting the length of pipe against traffic impact—that is, traffic-induced vibration which is transmitted through the ground. The encapsulation kit locates the length of pipe generally in place, although some shifting from this location may be permitted as described above.

In one arrangement, there is provided a reinforcing membrane comprising a material which is more resistant to pressure before incurring permanent shape change than a material of the first and second foam sections. The reinforcing membrane is carried at or adjacent a respective inside face of said one of the foam sections defining the bottom covering thereby lining a portion of the cavity for providing support for the length of pipe.

In one instance, the reinforcing membrane comprises a body of ethafoam forming a mat located at or adjacent said inside face of said one of the first and second foam sections defining the bottom covering.

In one instance, the reinforcing membrane comprises a body of rubber material forming a mat located at or adjacent said inside face of said one of the first and second foam sections defining the bottom covering.

In one instance, the reinforcing membrane comprises a body of plastic forming a sheet located at or adjacent said inside face of said one of the first and second foam sections defining the bottom covering.

The body of plastic may be embedded in said one of the first and second foam sections defining the bottom covering.

Preferably, an antifriction material is carried by a respective inside face of said one of the foam sections defining the bottom covering. That is, this antifriction material reduces friction between itself and the length of pipe such as that generated by movement of the pipe along or across the antifriction material so that pressure and stress on the length of pipe is reduced. For example, the antifriction material has a low coefficient of at least one of static or kinetic friction, especially with a material of the piping.

In one arrangement, there is provided a reinforcing membrane comprising a material which is more resistant to pressure before incurring permanent shape change than a material of the first and second foam sections, the reinforcing membrane being carried at or adjacent a respective outside face of at least one of the first and second foam sections that is exposable to the subterranean environment.

The reinforcing membrane may be embedded in said at least one of the first and second foam sections in a manner so as to be located at or adjacent the outside face thereof.

The first and second foam sections respectively may comprise a body of insulating foam.

Additionally or alternatively, the low density foam may comprise a volume of insulating foam.

At least one of the first and second foam sections may include a depression in an inside face thereof for locating the length of pipe in the cavity.

In one arrangement each one of the first and second foam sections are generally L-shaped in transverse cross-section so as to have a long leg and a short leg of each foam section.

Preferably, the long legs of the first and second foam sections are parallel to a width of the cavity which is measured between the short legs of the first and second foam sections disposed in the working configuration such that the width of the cavity is larger than a height of the cavity which is measured between the long legs of the first and second foam sections.

Each one of the first and the second foam sections may be regarded as including:
a channel collectively defined by at least a generally horizontal surface that extends in a longitudinal direction from a first end of the respective foam section to a second end thereof;
a pair of mating faces on either side of the channel arranged for butting engagement with that of the other one of the foam sections in the working configuration such that the channels of the first and second foam sections cooperatively form the cavity; and
an outer peripheral surface spanning from an outer side of a first one of the mating faces and about the channel to an outer side of a second one of the mating faces, at least a portion of the outer peripheral surface being spaced from the channel by a thickness of the respective foam section.

Preferably the channel of at least one of the first and second sections includes at least one upright surface. The at least one upright surface is useful for maintaining the length of pipe in position on the respective foam section prior to receiving the other one of the foam sections, and also prior to fully completing installation.

As such, for example the channel may be L-shaped in transverse cross-section (where there is one upright surface) or U-shaped (where there are two upright surfaces). In another example, the channel may have an arcuate or a semi-circular cross-section where a tangent thereof defines the horizontal surface and another tangent defines the at least one upright surface.

In one arrangement, the first and second foam sections at their mating faces include cooperating ridges and grooves for mating engagement with each other.

Preferably the respective ridge project beyond a respective one of the mating faces so as to form a pair of surfaces upstanding therefrom and forming a peak of the ridge which is spaced from said respective one of the mating faces.

Preferably the respective groove is recessed from a respective one of the mating faces so as to form a pair of surfaces depending therefrom and forming a base of the groove which is spaced from said respective one of the mating faces.

Preferably the upstanding surfaces of the respective ridge and the depending surfaces of the respective groove are arranged for butting engagement one with the other so as to locate the first and second foam sections in fixed transverse relation to one another.

Typically the cooperating ridges and grooves each extend longitudinally of the respective foam section such that the upstanding surfaces of the respective ridge face to either side of the longitudinally extending peak and the depending surfaces of the respective groove are arranged along either side of the longitudinally extending base of the respective groove.

Typically the cooperating grooves extend along a length of the respective foam section from the first end to the second end.

Typically the peak of the respective ridge is spaced from the outer side of the respective one of the mating faces and the base of the respective groove is spaced from the outer side of the respective one of the mating faces.

Typically the respective ridge and groove each are located generally centrally of the respective one of the mating faces so as to leave a portion of the mating face on either side of the one of the ridge and groove for engaging that of the mating face of the other one of the foam sections.

In one arrangement the respective foam section includes a passageway extending through the material of the respective foam section from an opening at the outer peripheral surface to an opening at the channel so that in the working configuration the cavity is accessible by apparatus located externally of the first and second foam sections. Thus typically the passageway traverses a thickness of the material on its path from one opening to the other.

For example, the apparatus comprises cathodic protection equipment which is connected to the pipe arranged in the cavity and at another location externally of the first and second foam sections forming the cavity.

Typically there are a plurality of the passageways located at longitudinally spaced positions of the respective foam section.

The plurality of the passageways may be arranged in a plurality of rows with each passageway staggered relative to a pair of the passageways between which the respective passageway is located.

In one arrangement the passageway follows a linear path from the outer peripheral surface to the channel.

In one arrangement the opening of the passageway at the channel is disposed in the horizontal surface thereof and the channel extends in a linear path therefrom to the outer peripheral surface.

According to another aspect of the invention there is provided a combination of a pipe which is disposable underground in a subterranean environment and has a pre-specified diameter and an encapsulation system for preserving said pipe, the combination comprising:
elongate first and second foam sections extending in a longitudinal axis along the pipe that are shaped so as to cooperatively form a longitudinally elongate cavity with open longitudinal ends in a working configuration of the foam sections;
the cavity having a height and a width which are measured transversely to one another and to the longitudinal axis, the height and width of the cavity being sized at least equal to the pre-specified diameter of the pipe;
a length of the pipe received in said cavity formed by the first and second foam sections disposed in the working configuration such that the length of the pipe is enclosed by the first and second foam sections around its full circumference so as to be shielded thereabout;
one of the foam sections defining a bottom covering usable for positioning beneath the length of the pipe and one of the foam sections defining a top covering usable for positioning over the length of the pipe;
a securing arrangement holding the first and second foam sections in the working configuration;
a volume of low density foam which is less dense than a material of the first and second foam sections filling an unoccupied space within the cavity to either side of the length of the pipe so as to cushion the length of the pipe such that movement of the length of the pipe within the cavity is permitted and stress on the length of the pipe is reduced.

In one arrangement, there is provided a reinforcing membrane comprising a material which is more resistant to pressure before incurring permanent shape change than a material of the first and second foam sections that is carried at or adjacent a respective inside face of one of the first and second foam sections defining the bottom covering such that the reinforcing membrane is disposed at or adjacent a circumferential periphery of the length of the pipe. Thus, the reinforcing membrane lines a portion of the cavity so as to provide support for the length of the pipe resting therein.

The width of the cavity may be sized on the order of at least twice the pre-specified diameter of the length of the pipe. Thus, sufficient room may be provided in the cavity for the low density foam to reside therein such that the length of the pipe is adequately cushioned.

Preferably, each of the top and bottom coverings has a predetermined thickness as measured along the height of the cavity that is on the order of the pre-specified diameter of the length of the pipe.

In one arrangement, there is provided at least two of one of the first and second foam sections disposed end-to-end on a common side relative to the circumference of the length of the pipe, a junction between ends of said at least two of said one of the first and second foam sections that are facing each other being filled with the low density foam to afford shifting between said at least two of said one of the first and second foam sections relative to each other.

In one arrangement, the first and second foam sections are offset from each other in a direction along the longitudinal axis so as to present a portion of a respective inside face thereof for overlapping by another one of the opposite one of the first and second foam sections.

According to another aspect of the invention there is provided a kit for encapsulating a length of pipe which is disposable underground in a subterranean environment and has a pre-specified diameter, the kit comprising:
elongate first and second foam sections extending in a longitudinal axis along the length of pipe and generally L-shaped in transverse cross-section so as to have a long leg and a short leg of each foam section;
the L-shaped foam sections forming a longitudinally elongate cavity with open longitudinal ends and a rectangular cross-section in a working configuration of the first and second foam sections for receiving the length of pipe in said cavity so as to enclose the length of pipe around its full circumference thereby shielding the length of pipe, wherein one of the foam sections defines a bottom covering usable for positioning beneath the length of pipe and one of the foam sections defines a top covering usable for positioning over the length of pipe.

Typically there is provided a securing arrangement for holding the first and second foam sections in the working configuration;

Typically there is provided a volume of low density foam which is less dense than a material of the first and second foam sections for filling unoccupied space in the cavity so as to provide cushioning for the length of pipe such that movement of the length of pipe within the cavity is permitted and stress on the length of pipe is reduced.

In one arrangement, there is provided a reinforcing membrane comprising a material which is more resistant to pressure before incurring permanent shape change than a material of the first and second foam sections that is carried at or adjacent a respective inside face of said one of the foam sections defining the bottom covering thereby lining a portion of the cavity for providing support for the length of pipe.

According to an aspect of the invention there is provided a kit for encapsulating a length of pipe which is disposable underground in a subterranean environment and has a pre-specified diameter, the kit comprising:
elongate first and second foam sections extending in a longitudinal axis along the length of pipe that are shaped to cooperatively form a longitudinally elongate cavity with open longitudinal ends in a working configuration of the foam sections for receiving the length of pipe in said cavity so as to enclose the length of pipe around its full circumference thereby shielding the length of pipe, wherein one of the foam sections defines a bottom covering usable for positioning beneath the length of pipe and one of the foam sections defines a top covering usable for positioning over the length of pipe;
each of the first and second foam sections including:
a channel collectively defined by at least a generally horizontal surface that extends in a longitudinal direction from a first end of the respective foam section to a second end thereof;
a pair of mating faces on either side of the channel arranged for butting engagement with that of the other one of the foam sections in the working configuration such that the channels of the first and second foam sections cooperatively form the cavity; and
an outer peripheral surface spanning from an outer side of a first one of the mating faces and about the channel to an outer side of a second one of the mating faces, at least a portion of the outer peripheral surface being spaced from the channel by a thickness of the respective foam section; wherein the first and second foam sections at their mating faces include cooperating ridges and grooves for mating engagement with each other;
the respective ridge projecting beyond a respective one of the mating faces so as to form a pair of surfaces upstanding therefrom and forming a peak of the ridge which is spaced from said respective one of the mating faces;
the respective groove being recessed from a respective one of the mating faces so as to form a pair of surfaces depending therefrom and forming a base of the groove which is spaced from said respective one of the mating faces;
the upstanding surfaces of the respective ridge and the depending surfaces of the respective groove being arranged for butting engagement one with the other so as to locate the first and second foam sections in fixed transverse relation to one another.

Thus, at installation of the encapsulation kit, the ridge(s) of one of the foam sections mate with corresponding groove(s) of another one of the sections so as to resist relative movement of one foam section to the next.

In some arrangements each upright surface may meet the generally surface at an angle, for example 90 degrees, so as to form an edge between the adjacent surfaces where each one of the surface distinctly terminates.

In some arrangements the channel may be curved in transverse cross section so that the upright surface and the generally horizontal surface are contiguous where the channel transitions from one to the next.

Preferably the cooperating ridges and grooves each extend longitudinally of the respective foam section such that the upstanding surfaces of the respective ridge face to either side of the longitudinally extending peak and the depending surfaces of the respective groove are arranged along either side of the longitudinally extending base of the respective groove.

Thus in this arrangement mating of corresponding ridges and grooves acts to resist side-to-side movement of one of the foam sections relative to the other with which it is in abutment at its mating faces.

Preferably the cooperating grooves extend along a length of the respective foam section from the first end to the second end.

In this arrangement the first and second foam sections may be offset from each other in a direction along the longitudinal axis so that one of the foam section acts to bridge between two foam sections which are arranged end to end and both as bottom coverings or top coverings.

Preferably the peak of the respective ridge is spaced from the outer side of the respective one of the mating faces and the base of the respective groove is spaced from the outer side of the respective one of the mating faces.

In some arrangements the respective ridge and groove each are located generally centrally of the respective one of the mating faces so as to leave a portion of the mating face on either side of the one of the ridge and groove for engaging that of the mating face of the other one of the foam sections.

In one arrangement the respective foam section includes a passageway extending through the thickness of the respective foam section from an opening at the outer peripheral surface to an opening at the channel so that in the working configuration the cavity is accessible by apparatus located externally of the first and second foam sections.

Typically there is provided a volume of low density foam which is less dense than a material of the first and second foam sections for filling unoccupied space in the cavity.

The volume of low density foam provides cushioning for the length of pipe such that movement of the length of pipe within the cavity is permitted and stress on the length of pipe is reduced.

Typically a securing arrangement for holding the first and second foam sections in the working configuration.

According to an aspect of the invention there is provided a kit for encapsulating a length of pipe which is disposable underground in a subterranean environment and has a pre-specified diameter, the kit comprising:
elongate first and second foam sections extending in a longitudinal axis along the length of pipe that are shaped to cooperatively form a longitudinally elongate cavity with open longitudinal ends in a working configuration of the foam sections for receiving the length of pipe in said cavity so as to enclose the length of pipe around its full circumference thereby shielding the length of pipe, wherein one of the foam sections defines a bottom covering usable for positioning beneath the length of pipe and one of the foam sections defines a top covering usable for positioning over the length of pipe;
each of the first and second foam sections including:
a channel collectively defined by at least a generally horizontal surface that extends in a longitudinal direction from a first end of the respective foam section to a second end thereof;
a pair of mating faces on either side of the channel arranged for butting engagement with that of the other one of the foam sections in the working configuration such that the channels of the first and second foam sections cooperatively form the cavity; and
an outer peripheral surface spanning from an outer side of a first one of the mating faces and about the channel to an outer side of a second one of the mating faces, at least a portion of the outer peripheral surface being spaced from the channel by a thickness of the respective foam section;
wherein the respective foam section includes a passageway extending through the thickness of the respective foam section from an opening at the outer peripheral surface to an opening at the channel so that in the working configuration the cavity is accessible by apparatus located externally of the first and second foam sections.

Typically there are a plurality of the passageways located at longitudinally spaced positions of the respective foam section.

The plurality of the passageways may be arranged in a plurality of rows with each passageway staggered relative to a pair of the passageways between which the respective passageway is located.

In one arrangement the passageway follows a linear path from the outer peripheral surface to the channel.

In one arrangement the opening of the passageway at the channel is disposed in the horizontal surface thereof and the channel extends in a linear path therefrom to the outer peripheral surface.

In one arrangement the first and second foam sections at their mating faces include cooperating ridges and grooves for mating engagement with each other;

the respective ridge projects beyond a respective one of the mating faces so as to form a pair of surfaces upstanding therefrom and forming a peak of the ridge which is spaced from said respective one of the mating faces;

the respective groove is recessed from a respective one of the mating faces so as to form a pair of surfaces depending therefrom and forming a base of the groove which is spaced from said respective one of the mating faces; and

the upstanding surfaces of the respective ridge and the depending surfaces of the respective groove are arranged for butting engagement one with the other so as to locate the first and second foam sections in fixed transverse relation to one another.

Typically there is provided a volume of low density foam which is less dense than a material of the first and second foam sections for filling unoccupied space in the cavity.

The volume of low density foam provides cushioning for the length of pipe such that movement of the length of pipe within the cavity is permitted and stress on the length of pipe is reduced.

Typically there is provided a securing arrangement for holding the first and second foam sections in the working configuration.

### BRIEF DESCRIPTION OF THE DRAWINGS

Preferred arrangements of the invention will now be described in conjunction with the accompanying drawings in which:

FIG. 1 is a top plan view of a first arrangement of reinforced foam block.

FIG. 2 is a cross-sectional view along line A-A in FIG. 1 showing the first arrangement thereof.

FIG. 3 is a cross-sectional view along line B-B in FIG. 1 showing the first arrangement thereof.

FIG. 4 is a cross-sectional view as if along line A-A but showing a second arrangement of reinforced foam block.

FIG. 5 is a cross-sectional view as if along line A-A but showing a third arrangement of reinforced foam block.

FIG. 6 is a cross-sectional view as if along line A-A but showing a fourth arrangement of reinforced foam block.

FIG. 7 is a cross-sectional view as if along line B-B but showing a fifth arrangement of reinforced foam block.

FIG. 8 is a cross-sectional view as if along line B-B but showing a sixth arrangement of reinforced foam block.

FIG. 9 is a cross-sectional view as if along line B-B but showing a seventh arrangement of reinforced foam block.

FIG. 10 is a cross-sectional view as if along line B-B but showing an eighth arrangement of reinforced foam block.

FIG. 11 is a perspective view of one arrangement of encapsulation kit.

FIG. 12 is a cross-sectional view along line C-C in FIG. 11.

FIG. 13 is a cross-sectional view of another arrangement of encapsulation kit as if the cross-section were taken along line C-C and omitting some features for clarity of illustration.

FIG. 14 is a cross-sectional view of yet another arrangement of encapsulation kit as if the cross-section were taken along line C-C and omitting some features for clarity of illustration.

FIG. 15 is a cross-sectional view of a further arrangement of encapsulation kit as if it were taken along line C-C and omitting some features for clarity of illustration.

FIG. 16 is a cross-sectional view of a yet further arrangement of encapsulation kit as if the cross-section were taken along line C-C and omitting some features for clarity of illustration.

FIG. 17 is a side elevational view of a further arrangement of the encapsulation kit of FIG. 1 showing how more than two foam sections may be arranged together.

FIG. 18 is a top plan view of the arrangement of FIG. 17.

FIG. 19 is a cross-sectional view of another arrangement of encapsulation kit as if it were taken along line C-C and omitting some features for clarity of illustration.

FIG. 20 is a cross-sectional view of yet another arrangement of encapsulation kit as if it were taken along line C-C and omitting some features for clarity of illustration.

FIG. 21 is a perspective view of a further arrangement of encapsulation kit according to the present invention showing only one foam section with grooves for convenience of illustration.

FIG. 22 is an end view of the encapsulation kit according to the arrangement of FIG. 21 showing two foam sections in a separated condition for clarity of illustration.

FIG. 23 is a plan view of the encapsulation kit according to the arrangement of FIGS. 21 and 22. This figure may be taken to be a plan view of either one of the foam sections of FIG. 22 as they appear virtually identical in such plan view.

In the drawings like characters of reference indicate corresponding parts in the different figures.

### DETAILED DESCRIPTION

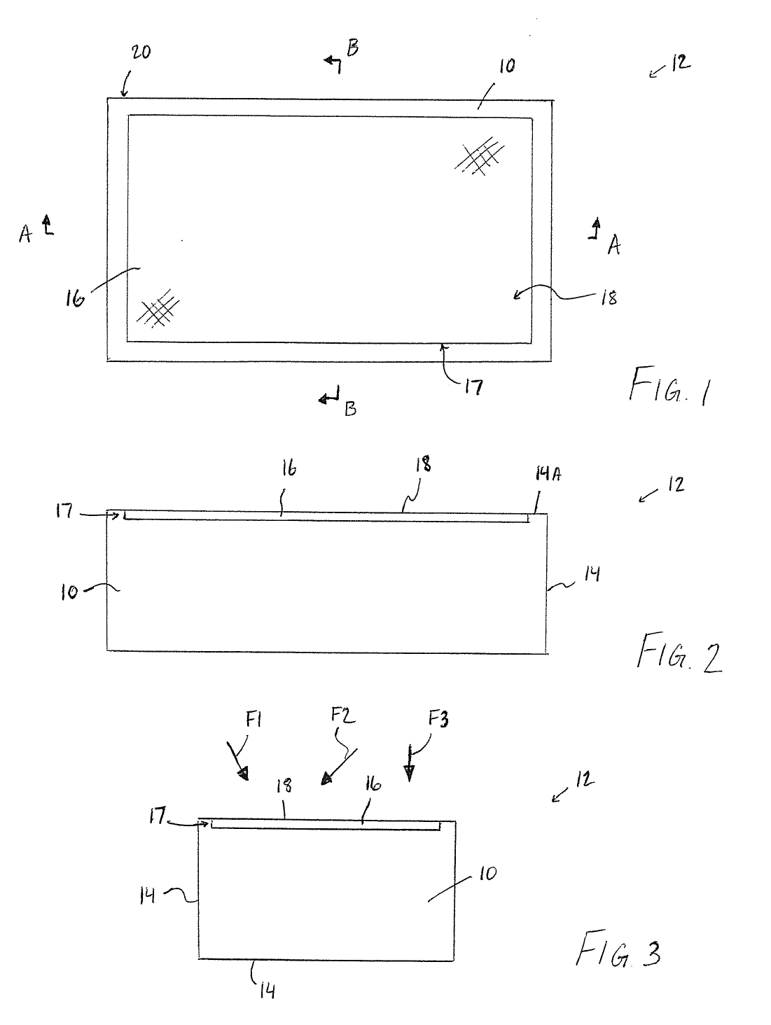

Referring to FIGS. 1 through 10, there are illustrated a number of preferred arrangements of reinforced foam block.

In this description, features which are common to all of the illustrated preferred arrangements are described first. Then, description of features which are unique with respect to the respective preferred arrangement follow thereafter. It will be understood that features which are described particularly with respect to one of the preferred arrangements of reinforced foam block may be combined in an appropriate manner with features specifically described with another one of the preferred arrangements.

The reinforced foam block comprises a body of foam material 10. For example, the foam material may comprise synthetic polymeric foam such as polyurethane foam. In certain applications, it may be preferred that the foam material comprises a thermally insulating foam, of which polyurethane foam is an example as well.

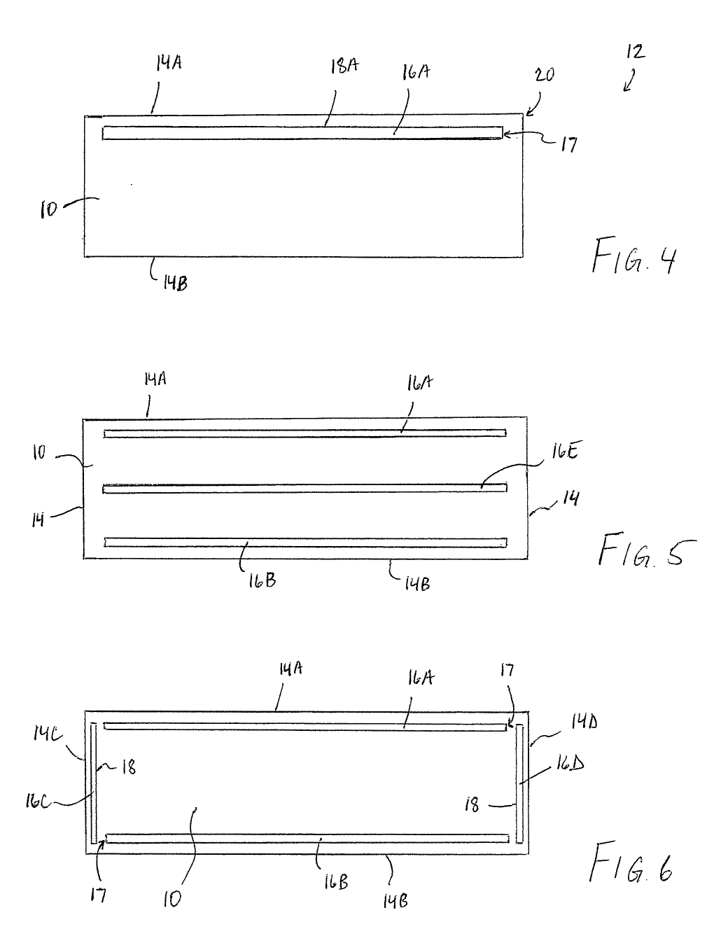

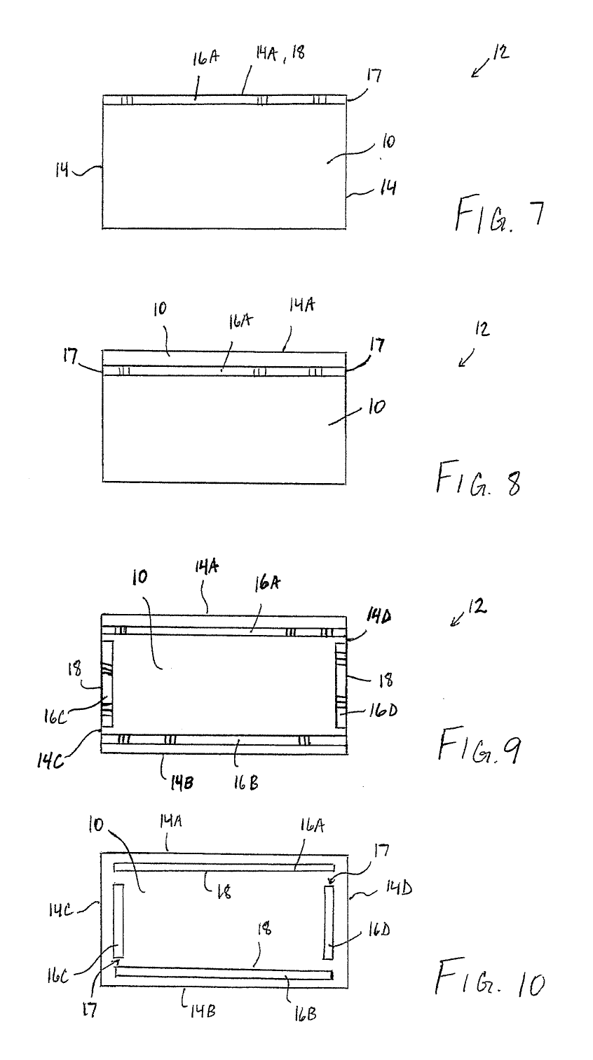

The body of foam material forms a three-dimensional main body 12 which has a volume and at least one peripheral face 14 with a predetermined surface area. That is, reference to ‘block’ in this specification is intended to not be limiting of shape of the block and includes any 3D shape. For example, the block may be shaped, in three dimensions, as a sphere, cylinder (for example circular cylinder, rectangular cylinder, and triangular cylinder), pyramid, etc. Typically, the main body 12 has a plurality of peripheral faces 14 which may be exposed to an external environment of the foam block, and therefore subject to forces exerted in directions transversely to the surface area of the respective peripheral face 14, such as those schematically indicated by arrows indicated at F1, F2, and F3 in FIG. 3 (which are spaced from the foam block for clarity of illustration). Since the foam material is suited for providing a cushioning effect due to its material properties, such foam blocks are typically subjected to compressive forces.

The reinforced foam block includes at least one body of reinforcing material 16 embedded within the main body 12. The reinforcing material has greater tensile strength than the foam material 10 forming the main body. As such, the reinforcing material 16 may be considered to be ‘more resistant to pressure’ than the foam material 10 before incurring permanent shape change. That is, in comparison to the foam material, the reinforcing material is less likely to become at least one of broken; penetrated or pierced; or split, divided, or otherwise reduced to fragments as a result of pressure exerted on this material. Pressure can be regarded as force applied per unit area, such that pressure and force are related to one another. Examples of suitable reinforcing material 16 include plastic, rubber, and geotextile. Additionally, the reinforcing material may comprise a permeable material. For example, the permeable material may be porous so as to have a plurality of openings, each of which is formed through a full thickness of the body of reinforcing material. As such, either one of plastic, rubber, and geotextile materials in a suitable form may be considered to be permeable. The reinforcing material may also be flexible so as to be suited for a degree of deformation in shape within the main body in accordance with a general application in which the foam block is provided as a cushion.

In the illustrated arrangements, each body of reinforcing material 16 forms a sheet with a predetermined thickness and a prescribed surface area delimited by a peripheral edge 17. The sheet may be may be polygonal shaped with nonlinear sides such that the sheet is not necessarily rectangular in shape with straight linear sides in alternative arrangements.

Each body of reinforcing material 16 is embedded in the body of foam material 10 so as to be carried by the body of foam material in prescribed position within the main body 12. A respective orientation of the reinforcing material body may vary from one arrangement to another. For example, the reinforcing sheet 16 may be parallel to a proximal peripheral face 14A to which the sheet is located closest, or the reinforcing sheet may be inclined with respect to the closest peripheral face 14A.

The main body 12 benefits from the provision of each body of reinforcing material in that each reinforcing material body provides strength to the main body against force applied to the main body in a direction transversely with respect to the prescribed surface area of the respective body of reinforcing material, for example as forces F1 through F3 as expressly shown in FIG. 3.

This enhancement in strength of the main body 12, provided by the body of reinforcing material, may be realized in a number of different ways including in a manner such that the reinforcing material acts to hold the foam material together so as to resist splitting or breaking up into smaller fragments under transversely applied forces.

Additionally or alternatively, the strength enhancement of the main body may be realized in a manner such that the body of reinforcing material 16 disperses a transversely applied force which is exerted on the main body, and which may be transmitted through the foam material to the reinforcing material body, over the prescribed surface of the body of reinforcing material. For example, the characteristic described in this paragraph may be attributed, at least to some degree, to material hardness of the reinforcing material—that is, resistance of the material to permanent shape change.

Location of the body of reinforcing material 16 within the main body, in relation to the peripheral faces 14 and peripheral edges 20 of the main body, may vary from one arrangement to another as demonstrated in FIGS. 1 through 10.

In one arrangement, a respective body of reinforcing material 16 is carried at or adjacent the respective peripheral face 14A. Additionally or alternatively, a respective body of reinforcing material 14 is spaced further from the peripheral face 14A so as to be more deeply situated in the main body than at a location at or adjacent the peripheral face, for example at a location approximately midway between diametrically opposite pair of peripheral faces 14A, 14B.

FIGS. 1 through 3 more clearly show a first arrangement of the reinforced foam block. In this first arrangement, the body of foam material 10 comprises a rectangular cylinder or rectangular prism. Furthermore, the body of reinforcing material 16 forms a rectangular sheet with uniform thickness over its entire prescribed surface area. In this illustrated first arrangement, the body of reinforcing material comprises a PVC plastic mesh (as schematically indicated in FIG. 1) such that the material is porous and thus permeable.

In terms of structure, the body of reinforcing material 16 of the first arrangement is located at one of the peripheral faces 14A of the main body so as to define a surface of this particular peripheral face. Therefore, one face 18 of the body of the reinforcing material is wholly uncovered across the face's surface area by any foam material and is thus exposed to an external surrounding environment of the main body. However, the reinforcing material body's peripheral edge 17 is spaced from or recessed from a peripheral edge 20 of the respective peripheral face 14A of the main body at which the reinforcing material body is located so as to be entirely surrounded by a thickness of the foam material disposed about the peripheral edge 17 of the reinforcing material body.

FIG. 4 more clearly illustrates a second arrangement of the reinforced foam block, which includes a single body of reinforcing material 16A located adjacent one of the peripheral faces 14A of the main body 12 but recessed therefrom. Therefore, a thickness of the foam material is disposed over the prescribed surface area of one face 18A of the body of reinforcing material 16A which is oriented parallel to the proximal peripheral face 14A near which the reinforcing material body is disposed. In this illustrated second arrangement, the thickness of the foam material between the proximal peripheral face 14A of the main body and the closest face 18A of the reinforcing sheet body is uniform across the surface area thereof. Furthermore, at least a pair of diametrically opposite edges of the reinforcing body that form the peripheral edge 17 thereof are spaced from the peripheral edge 20 of the proximal peripheral face 14A. In contrast, the remaining pair of opposing edges may be aligned with respective edges of the proximal peripheral face so as to be exposed to the external environment and generally flush with opposing peripheral faces which adjoin the proximal peripheral face, as more clearly shown in FIG. 8, for example. Alternatively, the entire peripheral edge 17 of the reinforcing body may be spaced from the peripheral edge of the proximal peripheral face as more clearly demonstrated in FIG. 1, such that the entirety of the body of reinforcing material is encapsulated in the foam material. Moreover, for example, the body of reinforcing material 16A in this second arrangement may comprise a sheet of stranded rubber, such as that which comprises a plurality of individual rubber strands aggregated in the form of a mat or interwoven in the form of a mat.

In general, whether the body of reinforcing material is fully encapsulated by the body of foam material or whether any portion of the reinforcing material body is exposed so as to be uncovered by foam material, as seen more clearly in FIG. 4 the body of reinforcing material is oriented in the main body in a manner so as to match a contour of the proximal peripheral face 14A of the main body. However, in alternative embodiments, the body of reinforcing material may be misaligned from the contour of the proximal peripheral face.

Turning now to FIG. 5, this figure more clearly illustrates a third arrangement of reinforced foam block including a plurality of bodies of reinforcing material 16A, 16B, 16E disposed in a virtually stacked array within the main body 12. More specifically, the reinforcing material bodies 16A, 16B, and 16E are disposed in spaced parallel fashion relative to one another so as to be separated by a thickness of foam material 10 disposed between each pair of adjacent reinforcing material bodies. As such, two outermost ones of the reinforcing bodies 16A and 16B are carried adjacent diametrically opposite peripheral faces 14A and 14B but recessed therefrom, and a third intermediate one of the reinforcing bodies 16E is disposed approximately midway between these opposing peripheral faces. Such a layered arrangement as illustrated may provide redundancy and added strength for an inside center portion of the main body over an arrangement having bodies of reinforcing material carried only at or adjacent the peripheral faces of the main body. Furthermore, in this third arrangement, for example, the reinforcing material may comprise geotextile material.

In FIG. 6, a fourth arrangement of reinforced foam block is more clearly shown and includes a plurality of bodies of reinforcing material 16A through 16D, each of which is carried at or adjacent one of the plurality of peripheral faces 14A through 14D of the main body. In the illustrated fourth arrangement, each reinforcing body is parallel to its proximal peripheral face (as indicated by matching appended letters) and recessed therefrom. With such an arrangement, the main body 12 is reinforced with a body of reinforcing material carried at or adjacent each peripheral face. Furthermore, of the four reinforcing bodies in the illustrated fourth arrangement, each diametrically opposite pair thereof 16A, 16B and 16C, 16D is carried in the main body 12 in spaced parallel fashion relative to one another. Additionally, faces 18 of smaller-sized ones of the reinforcing material bodies 16C and 16D generally overlap the peripheral edges 17 of larger-sized ones of the reinforcing material bodies 16A and 16B, although an amount of foam material is disposed between the overlapped faces and peripheral edges.

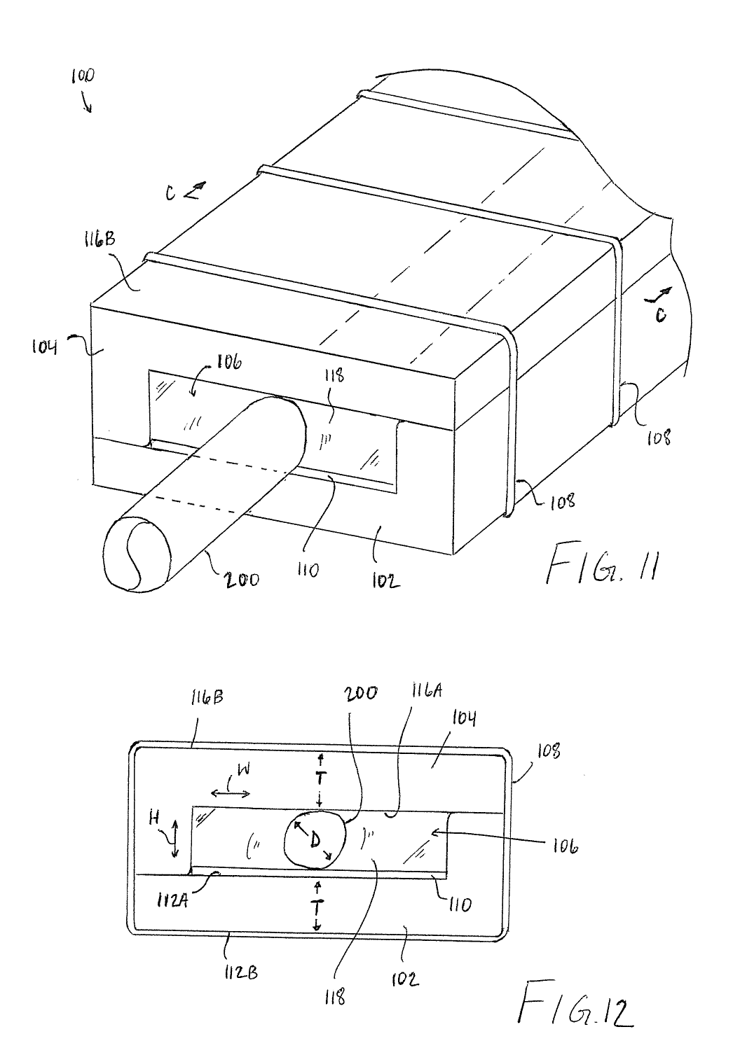

FIG. 7 more clearly shows a fifth arrangement of reinforced foam block in which the sheet body of reinforcing material 16A is located at one peripheral face 14A of the main body so as to define the full surface thereof and thus span the full predetermined surface area of this peripheral face. Furthermore, the sheet body's peripheral edge 17 is entirely exposed about its full periphery. As such, only one face of the sheet body is wholly covered by the foam material. Also, in the illustrated fifth arrangement, the body of reinforcing material comprises the body of permeable material (as schematically indicated in FIG. 7), such as the PVC mesh plastic, such that the foam material passes through a thickness of the permeable material body so as to hold same in the body of foam material 10. The foam material may pass through a partial thickness or through a full thickness of the sheet body of permeable material.

FIG. 8 more clearly illustrates a sixth arrangement of reinforced foam block in which the body of reinforcing material 16A is recessed from the proximal peripheral face 14A but the peripheral edge 17 of the reinforcing body is exposed so as to uncovered by any foam material. In this illustrated sixth arrangement, the body of reinforcing material comprises permeable material, such as that which is porous, such that the foam material passes through a thickness of the body of permeable reinforcing material so as to hold the reinforcing body within the main body.

Turning now to FIG. 9, this figure more clearly shows a seventh arrangement of reinforced foam block in which a plurality of bodies of reinforcing material 16A through 16D are disposed. In this illustrated seventh arrangement, one diametrically opposite pair of the reinforcing bodies 16A, 16B are recessed from proximal peripheral faces 14A, 14B closest to which each one of this opposing pair is located, with their peripheral edges 17 exposed at peripheral faces 14C, 14D adjoining the respective proximal face 14A or 14B. Also, each one of a second diametrically opposite pair of the reinforcing material bodies 16C, 16D is located at the respective proximal peripheral face 14C or 14D so as to define its surface and thus have a wholly uncovered, exposed face 18 of the respective body of reinforcing material.

In FIG. 10, an eighth arrangement of reinforced foam block is shown, in which a plurality of bodies of reinforcing material 16A through 16D are provided and each of these is recessed from a proximal peripheral face 14A through 14D closest to the respective reinforcing body so as to be fully covered, on all faces and peripheral edges, by the foam material. In contrast to FIG. 6, faces 18 of larger-sized ones of the reinforcing material bodies 16A and 16B generally overlap the peripheral edges 17 of smaller-sized ones of the reinforcing material bodies 16C and 16D, though an amount of foam material is disposed between the overlapped faces and peripheral edges.

Note that in the illustrated arrangements, each body of reinforcing material is sized such that its prescribed surface area, which is formed by one face of the reinforcing material body that is generally parallel to and facing (from the inside of the main body) a proximal peripheral face of the main body, is on the order of the predetermined surface area of the proximal peripheral face.

In other embodiments, multiple bodies of reinforcing material may be carried at a common peripheral face such that their collective surface area is on the order of the surface area of the proximal peripheral face. These multiple bodies of reinforcing material may be arranged in butting engagement with one another, or alternatively the multiple bodies of reinforcing material are spaced apart from one another so as to be separated by an amount of foam material between an adjacent pair of the reinforcing bodies carried at the common peripheral face.

In order to manufacture the reinforced foam block, the respective body of reinforcing material is disposed in a prescribed position in a chamber with an open top and closed bottom and held in place by a securing arrangement therein. A covering closes the open top of the chamber, and collectively the chamber and covering form a mold providing the shape of the main body 12. The foam material 10 is injected in liquid form through one of the covering and a chamber wall. The foam material then expands in the closed chamber so as to fill a remaining space in the mold which is unoccupied by the respective body of reinforcing material placed therein. Depending on the type of material employed for the reinforcing body, the foam material may pass through a thickness of the reinforcing body as the foam material expands thereby infusing the reinforcing material with the foam material. In the manner described in this paragraph, the respective body of reinforcing material is embedded in the main body and carried in its prescribed position in the main body by the foam material.

Referring to FIGS. 11 through 20, there is illustrated a kit for encapsulating a length of pipe 200 that is generally indicated by reference numeral 100. The kit for encapsulating the length of pipe is referred to as a ‘pipe encapsulation kit’ hereinafter in the description for convenience. The reinforced foam block may be suited for use in this encapsulation kit, as will become apparent with further description of this particular example in more detail hereinafter.

The pipe encapsulation kit 100 is suited for protecting piping which is disposed underground so as to reside in a subterranean environment. The piping or pipe may extend along an underground grade, that is at an elevation below the ground surface, such that the length of pipe is oriented substantially horizontally in the ground. The pipe 1 may also be oriented uprightly in the ground at riser sections of the pipeline where the piping traverses several underground grades in order to arrive at or extend away from equipment located at or near the ground surface. Furthermore, the length of pipe may follow a straight line path, a curved path at a bend section of the pipeline, or a serpentine like path with several curves in the path of the piping.

Underground, a length of pipe which is exposed to its external subterranean surroundings may be subject to stress from abrasive debris and contents in the ground, such as rocks, which directly engage the pipe and generate pressure points on the pipe surface. With prolonged stress and pressure points, which are exacerbated by movement of the pipeline such as due to thermal expansion and contraction thereof, longevity of the pipe decreases and likelihood of the pipe rupturing increases. Pipe ruptures and consequent leakage of the fluids carried by the pipeline can be costly for the pipeline operator and for the environment.

In order to shield the piping from the abrasive contents in the ground, the pipe encapsulation kit 100 comprises first and second foam sections 102 and 104. Each of the first and second foam sections extend in a respective longitudinal axis along the length of pipe 200 in a manner so as to be suited for covering a longitudinal length of the pipe. The two foam sections are shaped to cooperatively form a longitudinally elongate cavity 106 in a working configuration of the foam sections as more clearly shown in FIG. 11. That is, each foam section is shaped in transverse cross-section across its width so that, when the foam sections are disposed in the working configuration, the foam sections cooperate to form the cavity for receiving the length of pipe therein so as to enclose the length of pipe around its full circumference thereby shielding the length of pipe 200 from the subterranean environment. The cavity 106 formed in the working configuration spans a full longitudinal length of the foam sections 102, 104 and has open ends so that the pipe is receivable in the cavity. Additionally, the cavity has a height dimension and a width dimension which are measured transversely to one another and to the longitudinal axis. The height and width of the cavity are sized at least equal to a pre-specified diameter of the pipe ‘D’ which is encapsulated. In FIG. 12, double-headed arrows indicated at ‘H’ and ‘W’ illustrate general directions in which the height and the width of the cavity are measured respectively.

In the illustrated arrangements of FIGS. 11 through 16, each foam section is generally L-shaped in transverse cross-section so as to have a long leg and a short leg. Thus, the L-shaped foam sections arranged in the working configuration form a cavity having a rectangular cross-section with the long legs of each of the foam sections disposed opposite one another and the short legs disposed opposite one another. Furthermore, the foam material which makes up these foam sections 102, 104 can be considered to be ‘high density foam’ as will become apparent shortly. Generally speaking, in the working configuration, one of the foam sections (for example that indicated at 102) defines a bottom covering usable for positioning at the bottom of the pipe circumference and another one of the foam sections (for example that indicated at 104) defines a top covering usable for positioning at the top of the pipe circumference. ‘Bottom’ and ‘top’ typically refer to opposite locations with respect to the circumference of the pipe. Thus, when the length of pipe is generally horizontally oriented, the bottom covering is positioned beneath the length of pipe 200 and the top covering is positioned over the length of pipe. However, if the length of pipe is oriented uprightly, the bottom covering may not necessarily be lower than the top covering. Furthermore, each foam section may define one of the top covering and the bottom covering such that the top and bottom coverings are individual pieces, like the arrangements illustrated in FIGS. 11 through 20. For example, the L-shaped foam sections in the illustrated embodiment are disposed one on top of the other so that there is provided a first bottom foam section and a second top foam section. In other embodiments, a single foam section may define both the top and bottom coverings. For example, in an alternative embodiment, one of the foam sections may be generally C-shaped in cross-section and a second one of the foam sections may define an insert which is received between parallel branches of the C-shaped foam section so as to form the cavity in the working configuration.

Thus, the first and second foam sections 102 and 104 form an outer protective covering which shields the length of pipe from the external underground environment—in other words, the external subterranean environment.

A securing arrangement 108 is provided to hold the first and second foam sections 102, 104 together in the working configuration. In the illustrated arrangements of FIGS. 11 through 20, the securing arrangement 108 comprises a plurality of bands which ring around an outside of the foam sections about their transverse perimeter thereby snugly holding the foam sections together with one another in the working configuration.

Furthermore, in the illustrated arrangements of the encapsulation kit, an inner reinforcing membrane 110 is carried at or adjacent a respective inside face 112A of the bottom covering so as to be arranged to line a portion of the cavity 106. That is, the inner reinforcing membrane 110 lies along a boundary of the cavity. As such, the inner reinforcing membrane may be exposed to the cavity so as to directly engage a circumferential outer surface of the pipe 200, as more clearly shown in FIG. 12. Alternatively, the inner reinforcing membrane may be covered by a thickness of foam material over the inner reinforcing membrane's surface area so as to be spaced from the inside face 112A of the bottom covering but located closer to this inside face than to an opposite outside face 112B of the bottom covering. In either case, the inner reinforcing membrane comprises a body of material which has greater tensile strength than a material of the first and second foam sections so as to provide strength for the bottom covering. The inner reinforcing membrane 110 may dissipate at least a portion of the weight of the pipe and may act to hold the foam material of the bottom covering together without the foam material fragmenting under weight of the length of pipe 200.

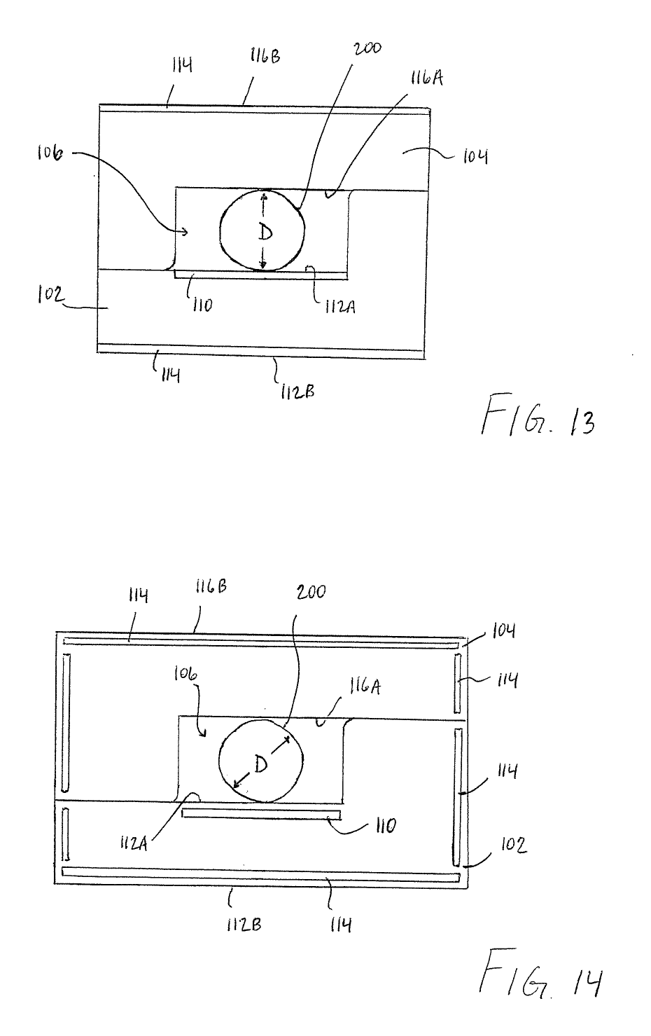

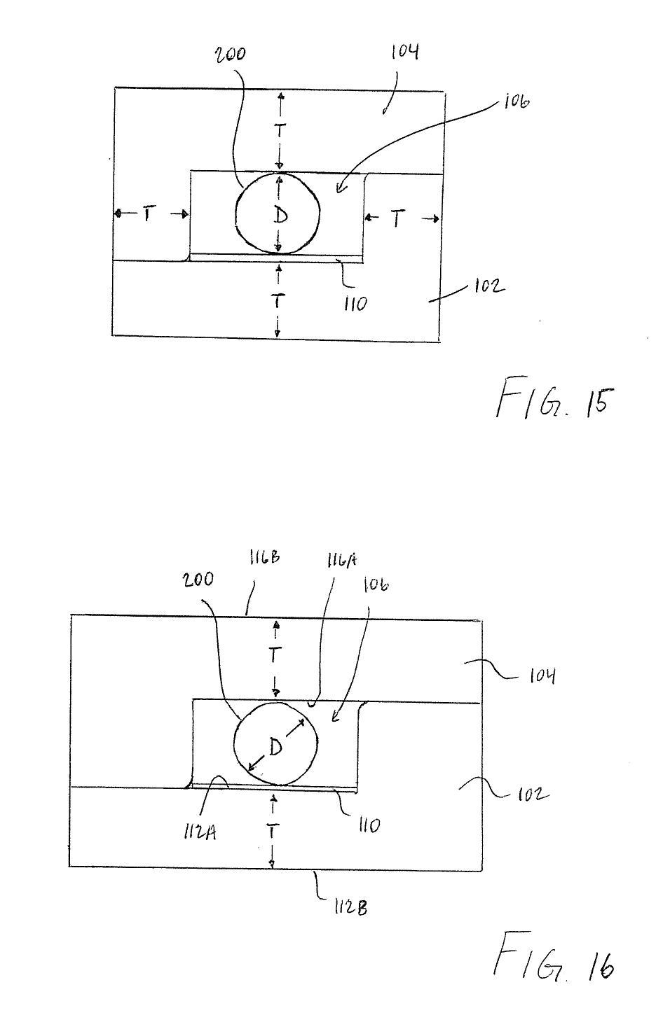

At least one outer reinforcing membrane 114 may also be provided as more clearly shown in FIGS. 13 and 14. The outer reinforcing membrane 114 is carried at or adjacent a respective outside face 1128, 1168 of at least one of the first and second foam sections, with the outside face being exposable to the subterranean environment. In the illustrated arrangements of the encapsulation kit, the outer reinforcing membranes 114 are located at or adjacent the outside face which is opposite to the inside face 112A, 116A of the respective foam section 102, 104. The outer reinforcing membrane may be located at the outside face so as to define its surface as for example shown in FIG. 13. Alternatively, the outer reinforcing membrane may be fully enveloped by foam material within a main body of the respective foam section as more clearly shown in FIG. 14. Similar to the inner reinforcing membranes, the outer reinforcing membranes provide strength for an outward facing shell of the foam sections. The outer reinforcing membrane comprises a body of material which has greater material hardness than the material of the foam sections. Therefore, the material of the outer reinforcing membrane may also be more resistant to pressure than the foam material of the foam sections. Thus, punctures through a full thickness of the foam sections due to sharp debris in the ground may be prevented. Furthermore, the outer reinforcing membranes may dissipate at least a portion of the weight of the subterranean environment exerting compressive forces on the foam sections, and may hold the foam material together under compressive forces of the subterranean environment on the foam sections in the working configuration.

Additionally, a volume of low density foam 118 is provided for filling any unoccupied space in the cavity 106 once the pipe 200 is received therein. The low density foam 118 is less dense than the material of the first and second foam sections 102, 104 so as to cushion the length of pipe 200 in a manner in which stress is reduced. That is, pressure from pressure points exerted directly on the outer foam section and transmitted therethrough may be dissipated by the low density foam. Therefore, as mentioned before, the material of the first and second foam sections may be considered to be high density relative to the low density foam 118. Furthermore, this lower density of the low density foam with respect to the foam sections allows a degree of movement of the length of pipe within the cavity while reducing stress on the pipe that is generated internally within the encapsulation kit by this movement. Returning now to the components of the pipe encapsulation kit in more detail, and turning first to the foam sections, the foam sections 102 and 104 are made from an insulating material so as to provide thermal insulation for the piping. For example, the foam sections are made of polyurethane foam which has thermal insulating properties. The polyurethane foam is injected into molds thereby producing the appropriately shaped foam sections.

The first and second foam sections 102 and 104 have a predetermined thickness ‘T’ where thickness is measured transversely with respect to the longitudinal axis of the foam sections and thus generally radially with respect to a center of the cavity 106 as better shown in FIGS. 15 and 16. More particularly, it is the top covering and bottom coverings (irrespective of the specific configurations of foam sections) which have the predetermined thickness of foam material as measured between an outer face 112B or 116B of the respective covering and an opposite inside face thereof 112A or 116A that defines a wall of the cavity in the working configuration of the foam sections. This predetermined thickness T is on the order of the pre-specified diameter D of the pipe 200 which is to be encapsulated. For example, the predetermined thickness T may be equal to the pre-specified diameter D. As such, the predetermined thickness T may lie in a first prescribed range of 1 to 40 inches. The predetermined thickness T may alternatively lie in a second prescribed range of 1.5 to 38 inches and provide similar functionality to that of the first prescribed range. Moreover, the predetermined thickness T may alternatively lie in a third prescribed range of 2 to 36 inches and provide similar functionality to that of the first and second prescribed ranges. Values of the prescribed ranges for the predetermined thickness correspond to typical diameter values of the piping used in pipelines. As more clearly shown in FIG. 15, the foam sections may also have the pre-determined thickness T of foam material between each one of outside faces, which lie to one side of the walls of the cavity which define the width W thereof, and the respective one of these walls.

The foam sections 102, 104 are also sized in order to provide a sufficiently large cavity 106. Typically, the width W of the cavity is sized larger than the height H of the cavity as shown in the illustrated arrangements. That is, in the illustrated embodiment, the width W is taken between cavity walls formed by the short legs of the foam sections and the height H is taken between cavity walls formed by the long legs of the foam sections. Thus, the width W of the cavity is sized on the order of at least twice the pre-specified diameter D of the length of the pipe. For example, the width W is equal to twice the pre-specified diameter D. Thus, sufficient room may be provided in the cavity 106 for the low density foam 118 to reside therein such that the length of the pipe is adequately cushioned. The height H of the cavity is sized on the order of the pre-specified diameter D of the pipe, such as slightly larger than the pre-specified diameter D, so that the length of pipe 200 is provided with some room to shift or expand in its size across the height dimension H of the cavity. Turning now to the inner reinforcing membrane 110, the inner reinforcing membrane of the illustrated arrangements more clearly shown in FIG. 12 which is exposed to the cavity 106 comprises a body of antifriction material so that friction between the inner reinforcing membrane and the length of pipe 200 is reduced, such as the friction generated by movement of the pipe along or across the inner reinforcing membrane. This reduction in friction is intended to reduce pressure and stress on the length of pipe. For example, the antifriction material comprises a sheet of ethafoam forming a mat on the inside face of the bottom covering. In another example, PVC plastic, such as rock shield which forms a mesh sheet, may be suited for use as the antifriction inner reinforcing membrane. In a further example, a body of rubber material, such as stranded rubber, forming a mat on the inside face of the bottom covering comprises the antifriction inner reinforcing membrane.

In the illustrated arrangements as more clearly shown in FIGS. 12 through 16, the inner reinforcing membrane 110 spans the full length and the full width of the cavity 106 so as to be rectangular in shape. Furthermore, the inner reinforcing membrane is centrally located with respect to the full width of the first bottom foam section 102 where the membrane is carried. The inner reinforcing membrane may be embedded in the foam section so as to be enveloped by the foam material of the foam section or infused therewith. Alternatively, the inner reinforcing membrane may be attached to the foam material of the respective foam section by an adhesive, for example a suitable glue. In the instance that the inner reinforcing membrane is located at the inside face of the bottom covering so as to define the surface thereof, the inner reinforcing membrane may be considered to be a sacrificial layer or membrane which directly engages the outer surface of the pipe.

Turning now to the outer reinforcing membrane 114, the outer reinforcing membrane may be embedded in the foam section so as to be enveloped by the foam material of the foam section or infused therewith. Alternatively, the outer reinforcing membrane may be attached to the foam material by a suitable adhesive. Furthermore, the outer reinforcing membranes may be placed at a plurality of the outside (outward facing) faces of the foam sections which are exposable to the external subterranean environment, as more clearly shown in FIG. 14.

Now turning to the low density foam 118, the low density foam resides in all of the unoccupied space in the cavity which is between the cavity walls and the pipe. In the illustrated embodiment, the low density foam 118 primarily resides to either side of the length of the pipe. As such, the low density foam snugly sandwiches the length of pipe 200 within the cavity 106 between the foam sections, with the provision of movement as discussed hereinbefore. Preferably, as shown more clearly in FIG. 12, the pipe is positioned within the cavity so as to be spaced from opposing sides of the cavity defining the width W thereof such that the volume of the low density foam is disposed across the full height H of the cavity on either side of the length of the pipe 200 so that a thickness of low density is provided around a full circumference of the pipe with the exception of where the pipe engages the inner reinforcing membrane 110. In this manner, side-to-side movement of the pipe within the cavity 106 may be sufficiently cushioned. The low density foam may comprise a material such as spray foam or a combination of spray foam and ethafoam. Furthermore, the low density foam may be sprayed so as to fill the cavity. According to the above description, the foam sections 102, 104 and reinforcing membranes 110, 114 and low density foam 118 collectively form a cocoon-like structure which envelops and encapsulates the length of pipe so as to preserve same. In other words, the aforementioned components form a shielding enclosure in the working configuration for the length of pipe 200. The pipe encapsulation kit 100 is suited for preventing pressure on the length of pipe, providing thermal insulation, cushioning expansion of the pipe, and thereby increasing longevity of the length of pipe and reducing possibility of failure thereof and blowouts.

A length value of the pipe that may be protected by the shielding enclosure comprising a pair of the foam sections depends on the individual lengths of the foam sections. Typically, both the first bottom and second top foam sections are identical in construction so as to have a common overall dimensions.

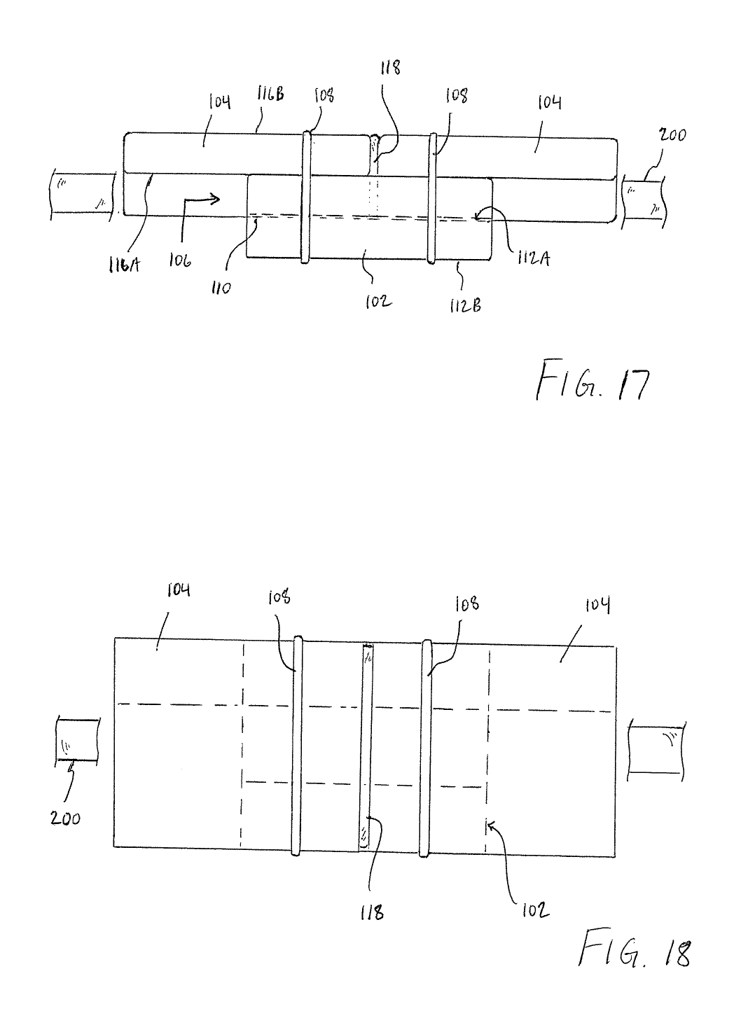

Depending on the application, different arrangements of the shielding enclosure may be employed. In one arrangement, a plurality of shielding enclosures can be installed at spaced intervals along the length of the pipeline so as to protect separate length portions of the pipe. For example, each of these shielding enclosures comprises the pair of foam sections aligned with one another along their lengths. In another arrangement, like that shown in FIGS. 17 and 18, a continuous uninterrupted length of pipe may be protected by arranging more than two foam sections end-to-end. In this particular arrangement for protecting the continuous uninterrupted length of the pipe, the first bottom foam sections (only one is shown in FIGS. 17 and 18) are disposed end-to-end to a common bottom side of the pipe and the second top foam sections are disposed to a common top side of the pipe in a similar manner as the bottom foam sections. Each pair of one first foam section and second foam section, which are opposite one another and collectively circumferentially enveloping a length portion of the pipe, are held together by the securing arrangement 108 such as the bands discussed hereinbefore. The first and second foam sections are offset from one another in a lengthwise direction along the longitudinal axis so as to present a portion of an inside face thereof 112A, 116A respectively for overlapping by another one of the opposite one of the first and second foam sections, so a majority of the respective foam sections are secured or banded to two of the oppositely designated foam section. Further to this, respective junction ends of each pair of adjacent first foam sections and each pair of adjacent second foam sections are filled with the low density foam 118 to afford shifting of one of said at least two foam sections relative to the other. FIG. 19 shows another arrangement of encapsulation kit according to the present invention in which each one of the foam sections 102, 104 is generally U-shaped so as to have two, transversely opposite short legs which are connected by a base spanning perpendicularly therebetween. Also, a volume of low density foam in the form of a pair of pads 118′ is disposed to either side of the length of pipe 200 in the cavity 106 such that a majority but not all of the cavity is occupied by the low density foam. Each pad 118′ covers an inside face of the respective short leg of the U-shaped foam section and a portion of the inside face 116A of the base. The respective pad 118′ is attached to at least one of the short leg and the base of the U-shaped foam section such as by a suitable adhesive. Furthermore, each pad 118′ is sized, for example by having a thickness, such that the unoccupied space as measured in a direction along the width W of the cavity is sized on the order of the diameter D of the length of pipe 200.

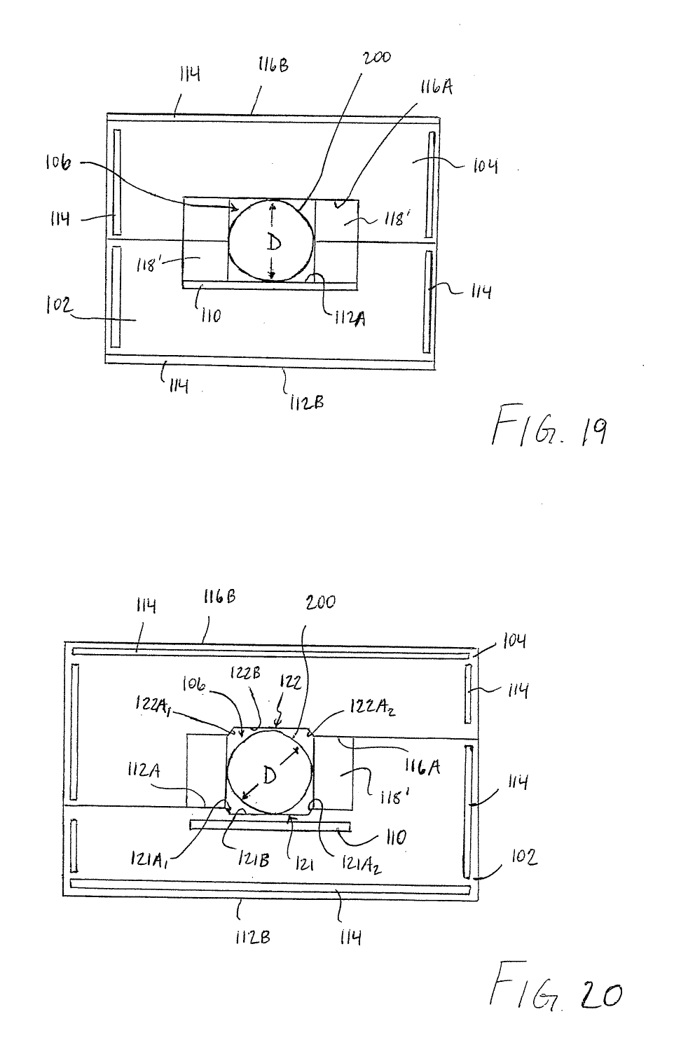

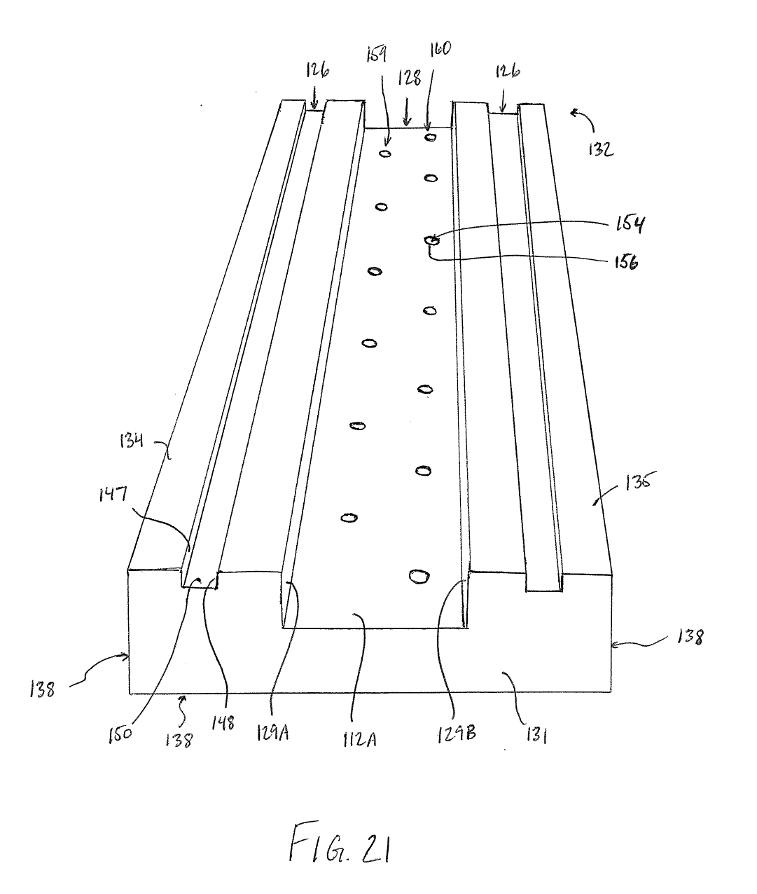

FIG. 20 shows yet another arrangement of encapsulation kit in which each of the foam sections 102, 104 includes a groove or depression 121, 122 in the inside face 112A, 116A of the respective foam section. The depression spans the full length of the respective foam sections and locates the length of pipe 200 in the cavity 106. Thus, the depression may be suited for reducing rolling movement during installation of the length of pipe across the respective inside face of the foam section that defines the bottom covering. As such, the cavity as measured between opposing depressions 121, 122 which are positioned diametrically opposite one another in the working configuration of the foam sections is sized on the order of the diameter D of the length of pipe 200, while the cavity between remaining portions of the inside faces 112A and 116A that are outside of the groove 121, 122 in the cavity provide a height which is less than the diameter D of the length of pipe. Also, in the illustrated arrangement each depression is formed by a series of planar surfaces, each contiguous with the next. Each depression 121, 122 comprises transversely opposite side portions 121A1/122A₁ and 121A₂/122A₂, which are inclined so as that the depression tapers inwardly from its outermost sides, and a flat main portion 121 B/122B which spans between the side portions. Additionally, the low density foam pads 118′ are disposed to either side of the length of pipe 200 and span a full height of the cavity between the remaining portions of the inside faces 112A and 116A alongside the depressions 121 and 122.

It is therefore appreciated that the reinforced foam blocks are suited for use in the encapsulation kit 100 for one or both of the foam sections. The reinforced foam blocks provide their respective bodies of reinforcing material 16 at strategic locations within the body of foam material 10 for strengthening the main body 12 of the foam block, thus providing a cushion which may be able to withstand significant compressive forces such as due to resting pipes down upon these blocks. The bodies of reinforcing material are also materially harder than the foam material, thereby being better suited for resisting punctures than the foam material.

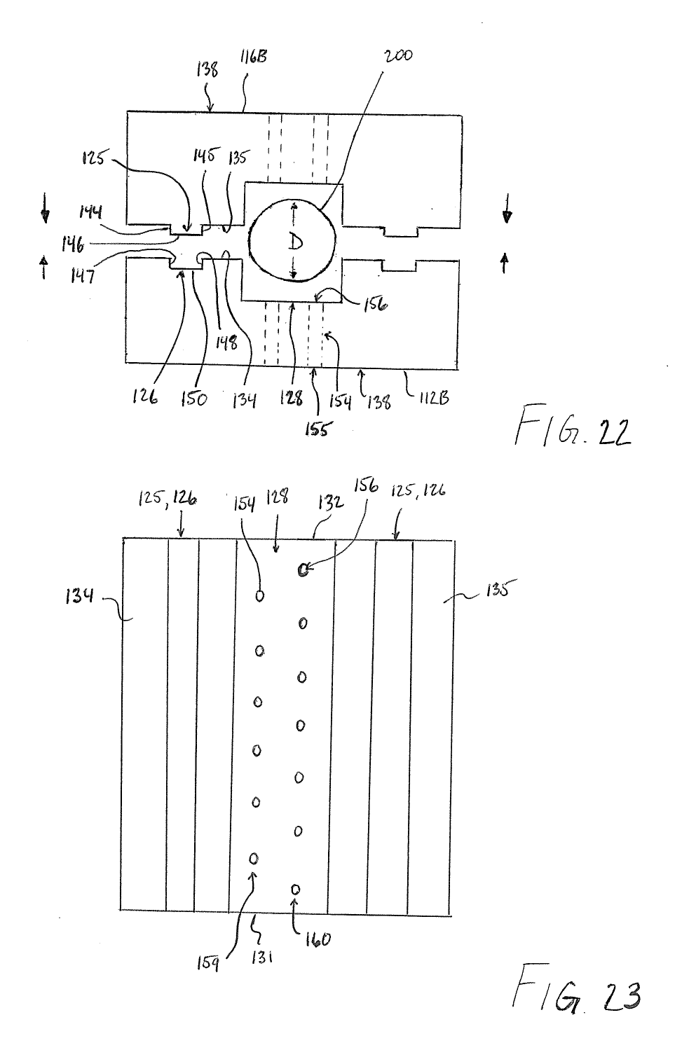

FIGS. 21-23 illustrate the foam blocks with additional features which include cooperating ridges 125 and grooves 126 for mating of bottom and top coverings so as to resist relative movement between the foam blocks, which is particularly useful at installation of the encapsulation kit before the bands 118 which press the blocks together are received thereover.

Each foam block may be regarded as having a channel 128 which is collectively defined by at least one upright surface and a generally horizontal surface meeting to form the channel of the respective foam block along which the length of pipe 200 is receivable. For example, as in the arrangement illustrated more clearly in FIG. 16 the channel 128 may comprise only one upright surface defined at an inner face of the short leg of the L-shaped section. The channel 128 may alternatively comprise a pair of upright surfaces as for example in the arrangement which is illustrated in FIG. 19 or 21 where the channel is generally U-shaped but the upright surfaces 129A and 129B meet the generally horizontal surface defined at the inside face 112A at right angles. The channel 128 extends longitudinally of the respective foam block and spans the full length thereof from a first end 131 of the block to a second end 132. Blocks which are shaped so as to follow a non-linear length of pipe, for example a block which is L-shaped along its length so as to follow a right angled length of pipe, are intended to fall within the scope of the specification herein.

On either side of the channel 128 there is a mating face 134 or 135 of the block. In the arrangement where the block is L-shaped in transverse cross-section, as for example in FIG. 16, one mating face is contiguous with the horizontal surface 112A of the channel 128 and a second mating face is distinct therefrom being located at a terminus of one of the legs of the which in FIG. 16 is the short leg. In the arrangement for example shown in FIG. 19 or 21, each mating face is distinct and spaced from a bottom of the channel. The mating faces 134, 135 are arranged for butting engagement with corresponding mating faces of the other foam block in the working configuration, as this is where each block forming the encapsulation contacts the other so as to form the cavity by alignment of their respective channels 128.

Further, each foam block has an outer peripheral surface 138 spanning from an outer side of a first one of the mating faces 134, about the channel 128, to an outer side of a second one of the mating faces 135. In the illustrated arrangements the outer peripheral surface 138 comprises three portions so as to have a flat bottom for example at 112B and flat sides indicated for example at 141 and 142. As such, the outer peripheral surface 138 of the respective block is spaced from the channel 128 by a thickness of the foam block which in this regard is not necessarily measured linearly between two faces of the foam block, as for example from the inside face 112A to the outside face 112B, but rather is intended to refer to that there is some distance to be traversed, following a path of some shape, through the foam block from the outer peripheral surface to the channel.

Thus, the ridge 125 or groove 126 is located at a mating face of the block. Each ridge 125 projects beyond the mating face where it is located so as to include a pair of side surfaces 144 and 145 upstanding from the mating face and forming a peak 146 of the ridge at a location spaced outwardly from the mating face. In the illustrated arrangement of FIG. 22, the peak 146 is a planar surface parallel to the mating face which also is substantially planar. In other arrangements (not shown) the peak may be a single edge extending along the ridge where the side surfaces meet one another.

The ridge 125 extends longitudinally of the foam block and spans the full length thereof from the first end 131 to the second end 132 of the block. As such, the side surfaces 144 and 145 face away from one another, with one facing towards the channel and the other towards the outer side of the respective mating face on which that ridge is located.

Furthermore, in the illustrated arrangement the ridge 125 is located generally centrally of the mating face where it is located, and is in this way spaced from the outer side of the mating face and from an inner side thereof where the channel commences, so as to leave a portion of the mating face on either side of the ridge where each mating face may engage the other in abutment.

Turning now to the grooves, each groove 126 is recessed from the mating face where that groove is located so as to form a pair of depending side surfaces 147 and 148 extending inwardly from the mating face to a base 150 of the groove which is spaced inwardly from the mating face.

As corresponding ridges and grooves cooperate with one another so as to hold each pair of top and bottom coverings in fixed transverse relation to one another, the grooves are shaped in a substantially corresponding manner to the ridges.

Thus, in the illustrated arrangement, the base 150 of the groove is a planar surface which is substantially parallel to the mating face, and the depending side surfaces 147 and 148 meet the base each at a right angle. In other arrangement, the depending side surfaces may taper towards one another so as to form an edge at the bottom of the groove that defines its base.

Each groove 126 extends longitudinally of the foam block and spans the full length thereof from the first to second end 131, 132 of the block. Thus, the depending side surfaces 147 and 148 face inwardly to one another along either side of the longitudinally extending base of the groove.

Furthermore, each groove is spaced from the outer side of the mating face where it is located and from the inner side thereof and is thus located generally centrally of the mating face leaving a portion of mating face on either side for abutment in the working configuration with the corresponding mating face of the other block.

As such, the upstanding side surfaces 144, 145 of the respective ridge 125 and the depending side surfaces 147, 148 of the groove 126 are arranged for butting engagement one with the other so as to resist relative side-to-side movement of each pair of foam blocks which are sandwiched together. In the illustrated arrangement the ridges and grooves are sized substantially equally in width from one side to the next so that when they are mated the foam blocks cannot be moved side to side. Moreover, in the illustrated arrangement the ridges and grooves each in their entirety is sized substantially equally so that the ridge peaks and groove bases abut one another in the working configuration. A height of the peak 146 of the ridge from its mating face is substantially equal to a depth of the base 150 of the groove from its mating face. As such, in the working configuration the respective ridge 125 is nested in the corresponding groove 126.

It will be appreciated that although in FIGS. 21-22 each foam block has only one of the ridges and the grooves, in other arrangements any one block may have both ridges and grooves.

As illustrated in FIGS. 21-23 there is also provided a plurality of conduits or passageways 154 in each foam block extending through the thickness of the foam block. Each passageway has a first opening 155 at the outer peripheral surface 138 and a second opening 156 at the channel 128 so that in the working configuration the cavity 106 is accessible from outside the encapsulation provided by the foam blocks. That is, the length of pipe 200 may be reached by apparatus, for example cathodic protection equipment, when the foam blocks are arranged in the working configuration while the encapsulation kit is still serving its purpose of shielding the length of pipe. As such, the passageways 154 may provide a path for current related to cathodic protection equipment to flow from the length of pipe within the cavity 106 to a location externally of the encapsulation kit.

The plurality of passageways 154 are arranged in an array in which the passageways are located at longitudinally spaced positions and are disposed in a staggered arrangement where each passageway located longitudinally intermediate a pair of adjacent passageways is spaced transversely therefrom so as to form a separate row. Thus the array of passageways forms a pair of rows 159 and 160 each extending longitudinally of the foam block.

Each passageway follows a linear path from the opening 156 in the horizontal surface of the channel 128 to the opening 155 at the planar bottom of the outer peripheral surface 138.

Since various modifications can be made in my invention as herein above described, and many apparently widely different embodiments of same made, it is intended that all matter contained in the accompanying specification shall be interpreted as illustrative only and not in a limiting sense.

1. A kit for encapsulating a length of pipe which is disposable underground in a subterranean environment and has a pre-specified diameter, the kit comprising:
elongate first and second foam sections extending in a longitudinal axis along the length of pipe that are shaped to cooperatively form a longitudinally elongate cavity with open longitudinal ends in a working configuration of the foam sections for receiving the length of pipe in said cavity so as to enclose the length of pipe around its full circumference thereby shielding the length of pipe, wherein one of the foam sections defines a bottom covering usable for positioning beneath the length of pipe and one of the foam sections defines a top covering usable for positioning over the length of pipe.

2. The kit for encapsulating a length of pipe according to claim 1 further including a securing arrangement for holding the first and second foam sections in the working configuration.

3. The kit for encapsulating a length of pipe according to claim 1 wherein there is provided a volume of low density foam which is less dense than a material of the first and second foam sections for filling unoccupied space in the cavity so as to provide cushioning for the length of pipe such that movement of the length of pipe within the cavity is permitted and stress on the length of pipe is reduced.

4. The kit for encapsulating a length of pipe according to claim 1 wherein each one of the first and second foam sections are generally L-shaped in transverse cross-section so as to have a long leg and a short leg of each foam section.

5. The kit for encapsulating a length of pipe according to claim 1 wherein:
each of the first and the second foam sections includes:
a channel collectively defined by at least a horizontal surface that extends in a longitudinal direction from a first end of the respective foam section to a second end thereof;
a pair of mating faces on either side of the channel arranged for butting engagement with that of the other one of the foam sections in the working configuration such that the channels of the first and second foam sections cooperatively form the cavity;
an outer peripheral surface spanning from an outer side of a first one of the mating faces and about the channel to an outer side of a second one of the mating faces, at least a portion of the outer peripheral surface being spaced from the channel by a thickness of the respective foam section;
wherein the first and second foam sections at their mating faces include cooperating ridges and grooves for mating engagement with each other;
the respective ridge projecting beyond a respective one of the mating faces so as to form a pair of surfaces upstanding therefrom and forming a peak of the ridge which is spaced from said respective one of the mating faces;
the respective groove being recessed from a respective one of the mating faces so as to form a pair of surfaces depending therefrom and forming a base of the groove which is spaced from said respective one of the mating faces;
the upstanding surfaces of the respective ridge and the depending surfaces of the respective groove being arranged for butting engagement one with the other so as to locate the first and second foam sections in fixed transverse relation to one another.

6. The kit for encapsulating a length of pipe according to claim 5 wherein the cooperating ridges and grooves each extend longitudinally of the respective foam section such that the upstanding surfaces of the respective ridge face to either side of the longitudinally extending peak and the depending surfaces of the respective groove are arranged along either side of the longitudinally extending base of the respective groove.

7. The kit for encapsulating a length of pipe according to claim 5 wherein the cooperating grooves extend along a length of the respective foam section from the first end to the second end.

8. The kit for encapsulating a length of pipe according to claim 5 wherein the peak of the respective ridge is spaced from the outer side of the respective one of the mating faces and the base of the respective groove is spaced from the outer side of the respective one of the mating faces.

9. The kit for encapsulating a length of pipe according to claim 5 wherein the respective ridge and groove each are located generally centrally of the respective one of the mating faces so as to leave a portion of the mating face on either side of the one of the ridge and groove for engaging that of the mating face of the other one of the foam sections.

10. The kit for encapsulating a length of pipe according to claim 1 wherein:
each of the first and the second foam sections includes:
a channel collectively defined by at least a horizontal surface that extends in a longitudinal direction from a first end of the respective foam section to a second end thereof;
a pair of mating faces on either side of the channel arranged for butting engagement with that of the other one of the foam sections in the working configuration such that the channels of the first and second foam sections cooperatively form the cavity;
an outer peripheral surface spanning from an outer side of a first one of the mating faces and about the channel to an outer side of a second one of the mating faces, at least a portion of the outer peripheral surface being spaced from the channel by a thickness of the respective foam section;
a passageway extending through the material of the respective foam section from an opening at the outer peripheral surface arranged to be in contact the subterranean environment to an opening at the channel so that in the working configuration the cavity is accessible by apparatus located externally of the first and second foam sections.

11. The kit for encapsulating a length of pipe according to claim 10 wherein there are a plurality of the passageways located at longitudinally spaced positions of the respective foam section.

12. The kit for encapsulating a length of pipe according to claim 11 wherein the plurality of the passageways are arranged in a plurality of rows with each passageway staggered relative to a pair of the passageways between which the respective passageway is located.

13. The kit for encapsulating a length of pipe according to claim 10 wherein the passageway follows a linear path from the outer peripheral surface to the channel.

14. The kit for encapsulating a length of pipe according to claim 10 wherein the opening of the passageway at the channel is disposed in the horizontal surface thereof and the channel extends in a linear path therefrom to the outer peripheral surface.
